(19) United States
(12) Patent Application Publication
(10) Pub. No.: US 2005/0048307 A1
(43) Pub. Date: Mar. 3, 2005

(54) Film for food packaging

(75) Inventors: Guenter Schubert, Rheinbach (DE); Guy Boiron, Wintzenheim (DE)

Correspondence Address: PROSKAUER ROSE LLP;PATENT DEPARTMENT, 1585 BROADWAY, NEW YORK, NY, 10036-8299, US

(73) Assignee: Hydro Aluminium Deutschland GmbH, Alcan Technology & Management AG

(21) Appl. No.: 10/501,319

(22) PCT Filed: Jan. 10, 2003
(86) PCT No.: PCT/EP03/00176

(30) Foreign Application Priority Data
Jan. 12, 2002 (DE) 102 00 925.2

(51) Int. Cl. B32B 15/08

(52) U.S. Cl. 428/607; 428/626; 428/654

(57) ABSTRACT

The invention relates to a film for food packaging, comprising at least one layer (1) made from an aluminium material. According to the invention, such a film may be improved, in particular with relation to the puncture resistance thereof whereby the film comprises at least one extruded layer (2) of a tear-resistant polymer.

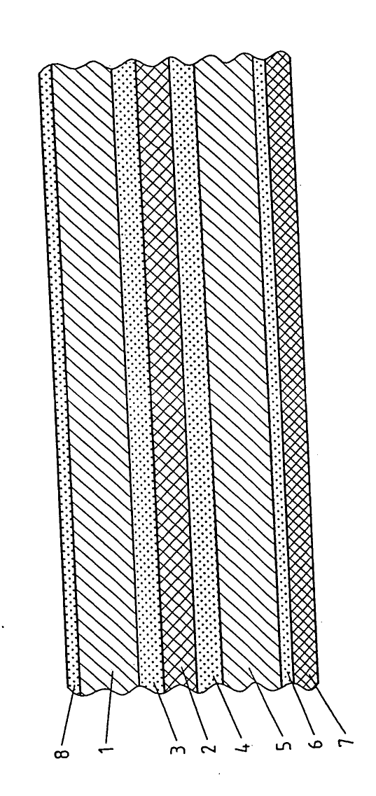

The invention relates to a foil, especially for food packagings, comprising at least one layer of an aluminium material.

Such foils are known in a plurality of forms. Mention may be made here of substantially thin aluminium foils having a thickness of about 5-60 μm and plastic composites having a thickness of about 10-100 μm with an aluminium layer deposited by evaporation.

In the case of thin aluminium foils, the comparatively low penetration strength is problematical with regard to the keeping quality of packaged foodstuffs and the mechanical strength of the foil. It is advantageous that aluminium foils are easily stamped whereby any adhesion of superimposed foils is avoided which is advantageous during the further processing of prefabricated foils.

A problem with plastic composites is that they are difficult to stamp because of the restoring capacity of the plastic films used and in addition, the barrier effect suffers during stamping. Also, plastic composites have a certain tendency to roll which, in the same way as the lack of stampability, makes the further processing of prefabricated foil sections significantly more difficult. However, plastic composites have improved penetration strength compared to thin aluminium foils.

On the basis of the prior art described previously, it is the object of the present invention to provide a foil for food packagings which ensures a very good penetration strength at the same time as easy further processability of prefabricated foil sections.

According to the invention the object derived previously and indicated is solved by the fact that the foil has at least one extruded layer of a tear-resistant polymer. As a result of the comparatively low stiffness of extruded layers of a tear-resistant polymer, the stampability of the layer of an aluminium material is retained. The tear resistance of the foil according to the invention is further improved compared with that of plastic composites by the fact that an extruded layer of a tear-resistant polymer has a significantly improved tear resistance compared with the plastic films of biaxially stretched polymers such as polyester, polyamide or polypropylene usually used in plastic composites. Not only the penetration strength but also the tearing strength and further tearing resistance are improved compared with the known foils for food packagings. In addition, the resistance capability to buckling fracture is significantly improved compared to thin aluminium foils. At the same time, the frequently desired optical impression of a thin aluminium foil is retained.

Since according to a first embodiment, the layer of an aluminium material is formed as aluminium foil, the stampability of the foil according to the invention and thus better further processability of prefabricated foil sections is ensured.

In addition, the thickness of the aluminium foil can be significantly reduced and thus the foil material according to the invention can be produced cheaply.

If the layer of an aluminium foil is alternatively formed as an aluminium layer deposited on a plastic film by evaporation, the tearing strength and further tearing resistance of such a foil is hereby improved substantially.

A simplification in the manufacture of a foil for food packagings according to the invention is ensured by providing a sealable layer co-extruded with the layer of tear-resistant polymer. The co-extrusion of the sealable layer together with the layer of tear-resistant polymer ensures a layer composition which makes a further extrusion coating on the seal side of the foil superfluous.

The tendency to roll and the optical properties of the foil according to the invention are improved by providing a second layer of an aluminium material and constructing the second layer as aluminium foil. As a result of the symmetry of this foil structure, such a foil shows almost no tendency to roll. In addition, the optical impression can be further improved by using for this purpose as desired the existence of a shiny and a matt side produced by the double rolling of the aluminium foils used to adjust the optics of the foil according to the invention. The appearance of the doubled foil barely departs optically and haptically from that of single-layer thin aluminium foils. Furthermore, there is also a substantial advantage in that thin foils with a relatively high number of pores can be laminated towards one another without the porosity in the composite having an effect, since—from the statistical point of view—the areas of action of pores in both foils rarely lie exactly above one another or overlap so that overall there is a high probability that a permeable site can be avoided.

Furthermore, the layer of tear-resistant polymer is a good barrier for oxygen and water vapour.

In the embodiment of the foil according to the invention just described the aluminium foils advantageously have a thickness of about 5 to 20 μm, whereby a considerable saving in material and thus a reduction in costs is ensured.

In order to ensure a secure bond between the extrusion-laminated layer of tear-resistant polymer and the layer of an aluminium material, according to one embodiment of the invention at least one adhesion-promoting layer co-extruded with the layer of tear-resistant polymer is provided between the layer of an aluminium material and the layer of tear-resistant polymer.

Since the properties of the foil according to the invention depend substantially on the properties of the tear-resistant polymer, the choice of tear-resistant polymer is particularly important. The layer of tear-resistant polymer provided according to the invention preferably consists at least partly of a polyamide, a partly crystalline, microcrystalline or amorphous polyamide, a polyester, a crystalline, partly crystalline or amorphous polyester, polypropylene, a high-density polyethylene, an olefin copolymer or ionomer, a cyclo-olefin copolymer, a liquid-crystalline or rigid-chain polymer, polymer blends or a reinforced polymer.

The use of liquid-crystalline polymers is advantageous if a specifically adjustable tearing behaviour is desired. This results from the fact that especially liquid-crystalline polymers only have a high tearing strength in one direction. The orientation of this tear-resistant direction relative to the mechanical loading to be predicted can result in desired effects such as a reproducible tearing pattern for example.

There are now a plurality of possibilities for shaping and further developing the foil according to the invention. For this purpose reference is made on the one hand for example to the claims inserted after claim 1 and on the other hand to the description of an exemplary embodiment in connection with the drawing.

In the drawings the single FIGURE shows the layer composition of an exemplary embodiment of a foil according to the invention for food packagings.

According to the invention the exemplary embodiment of a foil for food packagings shown in the single figure has a layer 1 of an aluminium material wherein in the exemplary embodiment shown this layer 1 is constructed as approximately 7 μm thick aluminium foil. According to the invention, the foil further has an extruded layer 2 of a tear-resistant polymer. The layer 2 of tear-resistant polymer is joined to the layer 1 of an aluminium material via an adhesive promoter layer 3 co-extruded with the layer 2 of tear-resistant polymer. As polymers for the layer 2 of tear-resistant polymer it is possible to use for example polyamide-6 (e.g., EMS, BASF, PA-66, DuPont, amorphous polyamides), polyester, amorphous polyester (e.g. from Eastman), polypropylene, HDPE and for adjusting stiffer middle layers, also cyclo-olefin copolymers such as COC Topas, liquid-crystalline polymers (LCP) such as Xydar or Vectra, polymer blends or reinforced polymers.

Modified polymers such as modified polyethylene or modified polypropylene are suitable as the adhesion-promoter layer 3.

The layer 2 of tear-resistant polymer is joined to a second layer 5 of an aluminium material via a second adhesive promoter layer 4 which is likewise preferably co-extruded jointly with the layer 2 of tear-resistant polymer and the first adhesion promoter layer 3. As a result of the symmetrical structure of the foil according to the invention thereby ensured, any tendency to rolling of the foil is avoided.

Merely for the sake of completeness, it is further shown in the single figure that the second layer 5 of an aluminium material is provided on its underside via a primer 6 with a sealable layer 7 whilst the upper side of the first layer 1 of an aluminium material is provided with a colour layer 8 as a result of a printing process.

The exemplary embodiment of a foil for food packagings according to the invention shown in the single figure remains dimensionally stable even during sealing of the foil with a suitable choice of melting region of the layer 2 of tear-resistant polymer. Thus, only a slight reduction in layer thickness of the layer 2 of a tear-resistant polymer occurs during heat sealing.

If rolling oil residue can be efficiently removed by flame treatment or corona treatment in-line directly before the extrusion laminating, hard-rolled aluminium foils can also be laminated to one another.

A typical thickness structure provides a first adhesion promoter layer 3 having a thickness of 3 μm, a layer 2 of tear-resistant polymer having a thickness of 4 μm and a second adhesion promoter layer 4 again having a thickness of 3 μm. Depending on the demands on the mechanical properties, the layer thicknesses can also be selected as higher or, depending on the performance of the resins and the extrusion technology, lower.

With polypropylene-based or especially resistant adhesion promoters, pasteurisability or sterilisation resistance (e.g. at 121° C., 2 bar) can also be achieved for a foil according to the invention.

The mechanical properties of the layer 2 of tear-resistant polymer and the reforming properties of the complete foil can be varied by the choice of tear-resistant polymer.

The foil according to the invention can be printed, varnished, laminated or coated using conventional methods.

The approximately 24 μm thick exemplary embodiment shown in the single figure (7 μm AL/10 μm co-extrusion layer/7 μm AL) is comparable with respect to manufacturing costs to a 30 μm AL strip but offers more favourable processing and usage properties than the pure AL strip.

Finally, the foil according to the invention can also be manufactured advantageously in terms of production technology since the co-extrusion coating can be carried out with immediate adhesion and adjustment of all the composite properties in one machine run without waiting for hardening times.

1. Foil for food packagings comprising at least one layer of an aluminium material, wherein the foil has at least one extruded layer of a tear-resistant polymer.

2. The foil according to claim 1, wherein the layer of an aluminium material is formed as aluminium foil.

3. The foil according to claim 1, wherein the layer of an aluminium material is formed as an aluminium layer deposited by evaporation onto a plastic film.

4. The foil according to claim 1, wherein a sealable layer co-extruded with the layer of tear-resistant polymer is provided.

5. The foil according to claim 1, wherein a second layer of aluminium material is provided and at least the second layer is constructed as aluminium foil.

6. The foil according to claim 5, wherein the aluminium foil has a thickness of 5 to 20 μm.

7. The foil according to claim 1, wherein at least on adhesion promoter layer co-extruded with the layer of tear-resistant polymer is provided between the layer of an aluminium material and the layer of tear-resistant polymer.

8. The foil according to claim 1, wherein the layer of tear-resistant polymer consists at least partly of an polyamide, a partly crystalline, microcrystalline or amorphous polyamide, a polyester, a crystalline, partly crystalline of amorphous polyester, polypropylene, a high density polyethylene, and olefin copolymer or ionomer, a cyclo-olefin copolymer, a liquid-crystalline or rigid-chain polymer, polymer blends or a reinforced polymer
